(19) United States
(12) Patent Application Publication
(10) Pub. No.: US 2022/0036360 A1
(43) Pub. Date: Feb. 3, 2022

(54) SERVER, NON-TRANSITORY COMPUTER READABLE MEDIUM, AND CONTROL METHOD

(71) Applicant: Toyota Jidosha Kabushiki Kaisha, Toyota-shi Aichi-ken (JP)

(72) Inventors: Yusuke Nakade, Nagoya-shi Aichi-ken (JP); Miho Otsuka, Nagoya-shi Aichi-ken (JP); Shunsuke Tanimori, Nagoya-shi Aichi-ken (JP); Hirokazu Kano, Nagoya-shi Aichi-ken (JP); Scott R. Meyer, Allen, TX (US); Michael C. Edwards, McKinney, TX (US)

(21) Appl. No.: 17/389,974

(22) Filed: Jul. 30, 2021

(30) Foreign Application Priority Data
Aug. 3, 2020 (JP) 2020-132045

(51) Int. Cl. G06Q 20/40; G06Q 20/34; G06Q 20/32

(52) U.S. Cl. CPC G06Q 20/4015; G06Q 20/322; G06Q 20/34

(57) ABSTRACT

A server is communicably connected to a vendor terminal and a vehicle, and includes a controller. The controller is configured to, upon receiving, from the vendor terminal, a request for electronic settlement in respect of a service, perform a comparison of a location where the service is to be provided with a location of the vehicle, which is associated with a settlement means used for settlement of the service, and when a result of the comparison is within an allowable range, authorize the electronic settlement.

### CROSS-REFERENCE T0 RELATED APPLICATION

This application claims priority to Japanese Patent Application No. 2020-132045 filed on Aug. 3, 2020, the entire contents of which are incorporated herein by reference.

### TECHNICAL FIELD

The present disclosure relates to a server, a program, and a control method.

### BACKGROUND

Technology in which a device that is installed in a gasoline station communicates with a vehicle to execute electronic settlement for refueling is known (for example, Patent Literature [PTL] 1).

### CITATION LIST

### Patent Literature

PTL 1: JP 2001-099660 A

### SUMMARY

According to PTL 1, above, the vehicle performs short-range wireless communication, thereby causing electronic settlement to be executed. There is room for improvement in terms of security in a case in which electronic settlement such as for refueling is executed without using the communication function of the vehicle.

It would be helpful to provide a server, a program, and a control method that are capable of improving security of electronic settlement.

A server according to an embodiment of the present disclosure is communicably connected to a vendor terminal and a vehicle, and includes a controller. The controller is configured to:

upon receiving, from the vendor terminal, a request for electronic settlement in respect of a service, perform a comparison of a location where the service is to be provided with a location of the vehicle, which is associated with a settlement means used for settlement of the service; and

when a result of the comparison is within an allowable range, authorize the electronic settlement.

A program according to an embodiment of the present disclosure is configured to cause a computer, as a server communicably connected to a vendor terminal and a vehicle, to execute:

receiving, from the vendor terminal, a request for electronic settlement in respect of a service;

performing a comparison of a location where the service is to be provided with a location of the vehicle, which is associated with a settlement means used for settlement of the service; and

when a result of the comparison is within an allowable range, authorizing the electronic settlement.

A control method according to an embodiment of the present disclosure is performed by a server communicably connected to a vendor terminal and a vehicle. The control method includes:

receiving, from the vendor terminal, a request for electronic settlement in respect of a service;

performing a comparison of a location where the service is to be provided with a location of the vehicle, which is associated with a settlement means used for settlement of the service; and

when a result of the comparison is within an allowable range, authorizing the electronic settlement.

The server, the program, and the control method according to an embodiment of the present disclosure may improve security of electronic settlement.

### BRIEF DESCRIPTION OF THE DRAWINGS

In the accompanying drawings:

FIG. 1 is a schematic diagram of an information processing system;

FIG. 2 is a block diagram illustrating a configuration of a server;

FIG. 3 is a block diagram illustrating a configuration of a vehicle;

FIG. 4 is a block diagram illustrating a configuration of a user terminal;

FIG. 5 is a diagram illustrating settlement;

FIG. 6 is a diagram illustrating a data structure of a request database (DB);

FIG. 7 is a diagram illustrating a data structure of a vendor terminal DB;

FIG. 8 is a diagram illustrating a data structure of a settlement means DB;

FIG. 9 is a diagram illustrating settlement according to another embodiment; and

FIG. 10 is a flowchart illustrating operations of the server.

### DETAILED DESCRIPTION

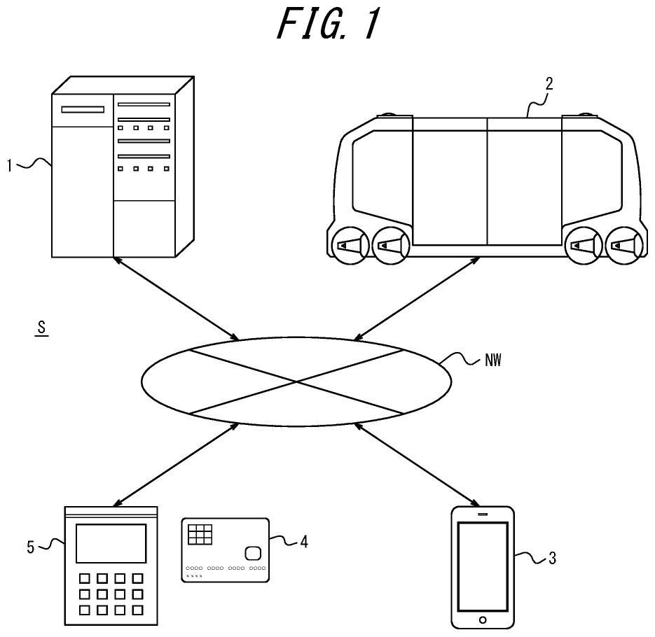

FIG. 1 is a schematic diagram of an information processing system S according to the present embodiment. The information processing system S includes a server 1, a vehicle 2, a user terminal 3, a settlement means 4, and a vendor terminal 5, which are communicably connected to each other via a network NW. For convenience of explanation, FIG. 1 illustrates one of each of the server 1, the vehicle 2, the user terminal 3, the settlement means 4, and the vendor terminal 5. However, the number of servers 1, the number of vehicles 2, the number of user terminals 3, the number of settlement means 4, and the number of vendor terminals 5 are not limited to one. The network NW includes, for example, a mobile communication network and the Internet.

An outline of processing that is executed by the server 1 according to the present embodiment will be described. Upon receiving, from the vendor terminal 5, a request for electronic settlement in respect of a service, the server 1 performs a comparison of a location where the service is to be provided with the location of the vehicle 2, which is associated with the settlement means 4, which is used for settlement of the service. When a result of the comparison is within an allowable range, the server 1 authorizes the electronic settlement. According to this configuration, when the location where the service is to be provided and the location of the vehicle 2 are within the allowable range, the electronic settlement is authorized. That is, when a user who receives the service exists within the allowable range from the vehicle 2 of the user, the server 1 authorizes the electronic settlement. Thus, the server 1 can improve the accuracy of user authentication, and therefore can reduce fraudulent use in which a third party impersonates the user to receive the service.

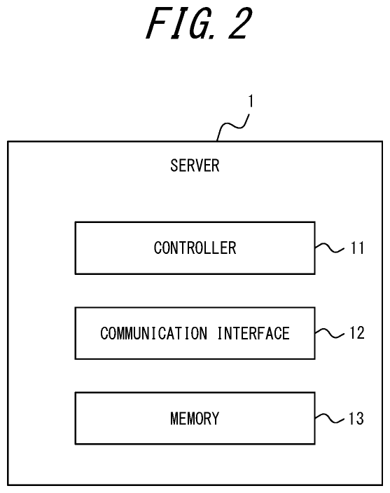

With reference to FIG. 2, an internal configuration of the server 1 will be described in detail.

The server 1 includes a controller 11, a communication interface 12, and a memory 13. The components of the server 1 are communicably connected to one another via, for example, a dedicated line.

The controller 11 includes, for example, one or more general-purpose processors including a Central Processing Unit (CPU) or a Micro Processing Unit (MPU). The controller 11 may include one or more dedicated processors that are dedicated to specific processing. The controller 11 may include one or more dedicated circuits instead of the processors. Examples of dedicated circuits may include a Field-Programmable Gate Array (FPGA) and an Application Specific Integrated Circuit (ASIC).

The communication interface 12 includes, for connecting to the network NW, one or more communication modules that conform to wired or wireless Local Area Network (LAN) standards. The communication interface 12 may include one or more modules conforming to mobile communication standards including the 4th Generation (4G) standard or the 5th Generation (5G) standard. The communication interface 12 may include one or more communication modules conforming to near field communication standards or specifications, including Bluetooth® (Bluetooth is a registered trademark in Japan, other countries, or both), AirDrop® (AirDrop is a registered trademark in Japan, other countries, or both), IrDA, ZigBee® (ZigBee is a registered trademark in Japan, other countries, or both), Felica® (Felica is a registered trademark in Japan, other countries, or both), or RFID. The communication interface 12 is configured to transmit and receive any appropriate information via the network NW. The any appropriate information includes, for example, positional information acquired through the Global Positioning System (GPS).

The memory 13 may be, but is not limited to, a semiconductor memory, a magnetic memory, or an optical memory. The memory 13 may function as, for example, a main memory, an auxiliary memory, or a cache memory. The memory 13 may store information resulting from analysis or processing performed by the controller 11. The memory 13 may store various types of information regarding operations and control of the server 1. The memory 13 may store a system program, an application program, embedded software, and the like. The memory 13 includes a request DB, a vendor terminal DB, and a settlement means DB. As an alternative example, the request DB, the vendor terminal DB, and the settlement means DB may be stored in a memory external to the server 1 and accessed from the server 1.

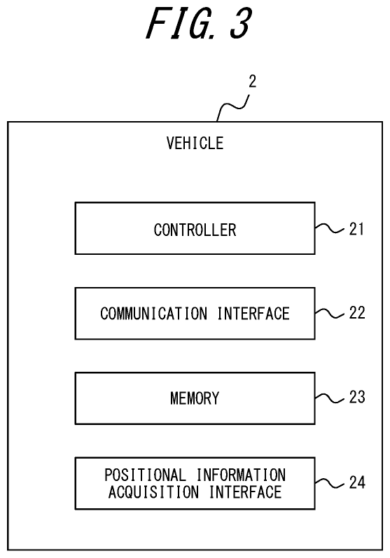

With reference to FIG. 3, an internal configuration of the vehicle 2 will be described in detail.

The vehicle 2 includes, for example, any type of automobile such as a gasoline vehicle, a diesel vehicle, an HV, a PHV, an EV, or an FCV. The term “HV” is an abbreviation of Hybrid Vehicle. The term “PHV” is an abbreviation of Plug-in Hybrid Vehicle. The term “EV” is an abbreviation of Electric Vehicle. The term “FCV” is an abbreviation of Fuel Cell Vehicle. In the present embodiment, the vehicle 2 is driven by a driver; however, its operation may be automated at any level in another embodiment. The automation level is, for example, any one of Level 1 to Level 5 according to the level classification defined by the SAE. The name “SAE” is an abbreviation of Society of Automotive Engineers. The vehicle 2 may be a MaaS-dedicated vehicle. The term “MaaS” is an abbreviation of Mobility as a Service.

The vehicle 2 includes a controller 21, a communication interface 22, a memory 23, and a positional information acquisition interface 24. The components of the vehicle 2 are communicably connected to one another via, for example, a dedicated line.

In the present embodiment, hardware components of the controller 21, the communication interface 22, and the memory 23 are the same as the hardware components of the controller 11, the communication interface 12, and the memory 13 of the server 1. Therefore, a description thereof is omitted here.

The positional information acquisition interface 24 includes, for example, an antenna. The positional information acquisition interface 24 acquires positional information for the vehicle 2 using, for example, the GPS.

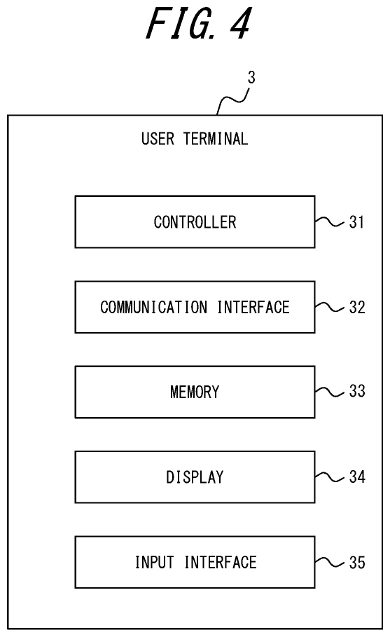

With reference to FIG. 4, an internal configuration of the user terminal 3 will be described in detail.

The user terminal 3 is a terminal held and used by the user. The user terminal 3 may be, for example, a mobile device including a mobile phone, a smartphone, or a tablet.

The user terminal 3 includes a controller 31, a communication interface 32, a memory 33, a display 34, and an input interface 35. The components of the user terminal 3 are communicably connected to one another, for example, via a dedicated line.

Hardware components of the controller 31, the communication interface 32, and the memory 33 are the same as the hardware components of the controller 21, the communication interface 22, and the memory 23 of the vehicle 2. Therefore, a description thereof is omitted here.

The display 34 is a display interface and includes, for example, a panel display. The display 34 may display information read from the memory 33, or information generated by the controller 31.

The input interface 35 includes one or more input interfaces that detect user inputs and send input information to the controller 31. Examples of input interfaces may include, but are not limited to, a physical key, a capacitive key, a touch screen integrally provided in the panel display, a microphone configured to receive audio input, and an IC card reader.

Again, with reference to FIG. 1, the settlement means 4 is a medium used for payment transactions. The settlement means 4 may be, for example, a credit card, a debit card, a prepaid card, and a payment-enabled mobile device. In the present embodiment, as an example, a case in which the settlement means 4 is a credit card will be described. As an alternative example, the user terminal 3 may be the settlement means 4.

The vendor terminal 5 is a settlement terminal provided in a vendor facility, a vendor store, or the like. The vendor terminal 5 may be, for example, a register or a point-of-sale (POS) terminal. The vendor terminal 5 reads information stored in the settlement means 4 in a contact or contactless manner, and transmits a request for electronic settlement to the server 1 together with information on the settlement amount. The information stored in the settlement means 4 includes, for example, a settlement means ID, an account number, an expiration date, and a holder's name. When the electronic settlement is authorized by the server 1, the vendor terminal 5 completes the electronic settlement.

Hereinafter, processing executed in the information processing system S according to the present embodiment will be described in detail. Here, a scenario in which a user U01 drives the vehicle 2 and stops by a gasoline station for refueling will be described as an example. Here, the ID of the vehicle 2 is V01. The gasoline station is an example and may alternatively be substituted by any other facility or store, such as a restaurant or shopping mall.

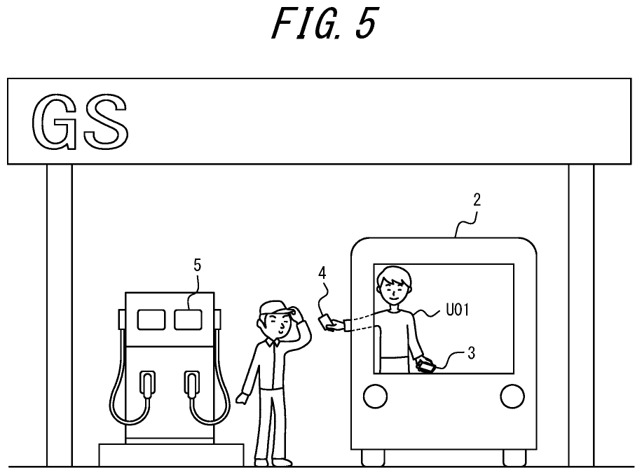

As illustrated in FIG. 5, upon arriving at the gasoline station, the user U01 passes the settlement means 4 to an employee of the gasoline station in order to settle the charge for refueling. The employee swipes the settlement means 4, which he has received, through the vendor terminal 5. In this situation, the vendor terminal 5 reads at least the settlement means ID from the settlement means 4. The vendor terminal 5 transmits to the server 1 a settlement request including a vendor terminal ID of the vendor terminal 5 and the settlement means ID.

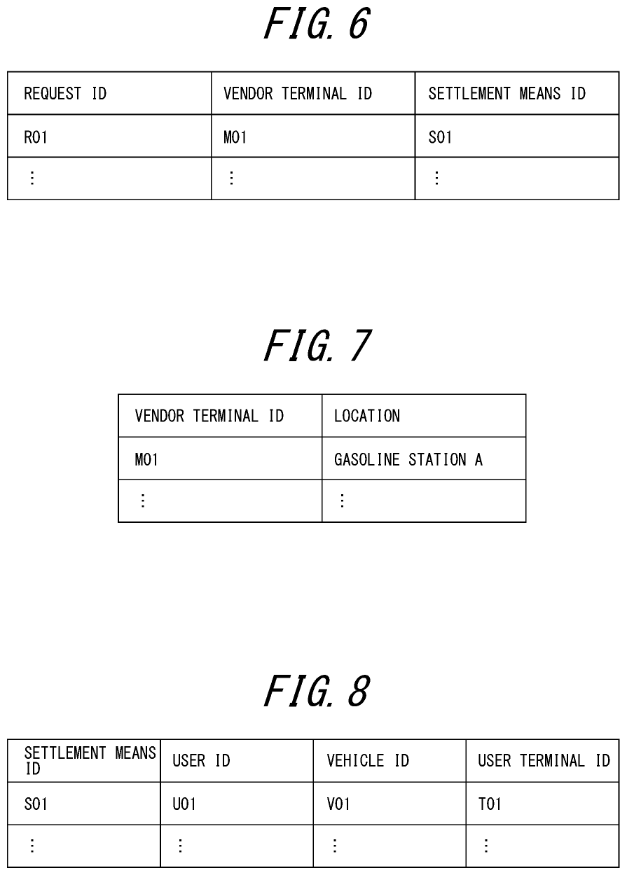

Upon receiving the settlement request, the controller 11 of the server 1 stores the settlement request in the request DB as illustrated in FIG. 6. As illustrated in FIG. 6, the request DB stores the vendor terminal ID and the settlement means ID in association with a request ID. The controller 11 of the server 1 refers to the request DB to identify that the vendor terminal ID included in the settlement request is MO1. The controller 11 of the server 1 refers to the vendor terminal DB illustrated in FIG. 7. The vendor terminal DB stores, in association with the vendor terminal ID, the location where the vendor terminal 5 is installed. The location where the vendor terminal 5 is installed is included in the location where the service is to be provided. The controller 11 of the server 1 identifies that the location stored in association with the vendor terminal MO1 is “gasoline station A”. The controller 11 of the server 1 searches for the location of the gasoline station A in any appropriate manner.

The controller 11 of the server 1 identifies that the settlement means ID included in the settlement request is S01. The controller 11 of the server 1 refers to the settlement means DB illustrated in FIG. 8. The settlement means DB stores a user ID of the holder in possession of the settlement means 4, a vehicle ID of the vehicle used by the holder in possession of the settlement means 4, and a user terminal ID of the user terminal held by the holder of the settlement means 4, in association with the settlement means ID. As an alternative example, the user terminal ID may be the ID of a user terminal of a guardian of the holder in possession of the settlement means 4. The controller 11 of the server 1 identifies that the vehicle ID stored in association with the settlement means S01 is V01.

The controller 11 of the server 1 acquires, from the vehicle 2, the positional information indicating the location of the vehicle 2 the vehicle ID of which is V01.

The controller 11 of the server 1 compares the location of the vehicle 2 with the location of the gasoline station A. The controller 11 of the server 1 determines whether a result of the comparison is within the allowable range. For example, when the vehicle 2, as illustrated in FIG. 5, exists in the premises of the gasoline station A, which is a store including the location where the service is to be provided, the result of the comparison is within the allowable range. The premises of the gasoline station A may be within a geo-fence that marks off the gasoline station A. Then, the controller 11 of the server 1 authorizes the electronic settlement. The controller 11 of the server 1 may alternatively authorize the electronic settlement when an additional condition is further met. Such an additional condition may be that the amount used is within the limit amount, that the current date and time is within the expiration date, or the like.

Upon determining that the result of the comparison is outside the allowable range, the controller 11 of the server 1 refers to the settlement means DB to identify that the user terminal ID stored in association with the settlement means S01 is T01. In the present embodiment, the terminal the user terminal ID of which is T01 is the user terminal 3. The controller 11 of the server 1 notifies the user terminal 3 that the settlement request has been made.

Upon receiving the notification, the user terminal 3 displays, on the display 34, a screen that requests a determination whether to permit the settlement. Upon receiving an instruction from the user that indicates permission or rejection of the settlement, the user terminal 3 transmits, to the server 1, information indicating the content of the instruction.

Upon receiving a notification indicating permission of the settlement, the controller 11 of the server 1 authorizes the electronic settlement. Upon receiving a notification indicating rejection of the settlement, the controller 11 of the server 1 rejects the electronic settlement.

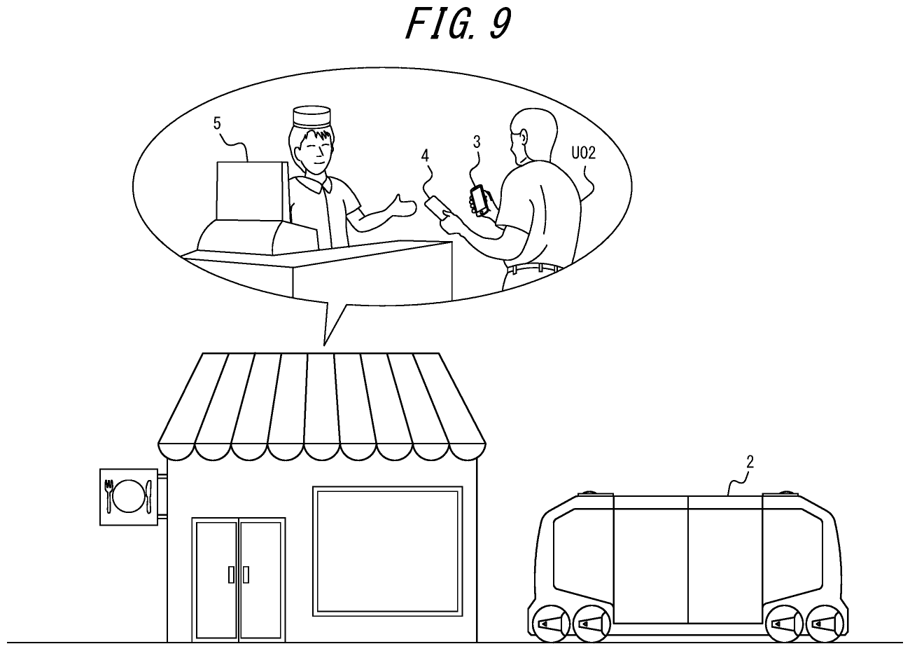

As an alternative example, when a user U02 uses the settlement means 4 in a restaurant as illustrated in FIG. 9, the controller 11 of the server 1 may also execute similar processing. For convenience of explanation, duplicate descriptions will be omitted. Specifically, the controller 11 of the server 1 compares the location of the vehicle 2 with the location of the restaurant. The controller 11 of the server 1 determines whether a result of the comparison is within the allowable range. When the location of the vehicle 2 is included in a parking lot of the restaurant, which is a store including the location where the service is to be provided, the result of the comparison is within the allowable range. The parking lot of the restaurant may be within a geo-fence that marks off the parking lot. Alternatively, when the location of the vehicle 2 is included within a predetermined distance from the location where the service is to be provided, the result of the comparison may be within the allowable range. The predetermined distance may be, for example, 100 meters.

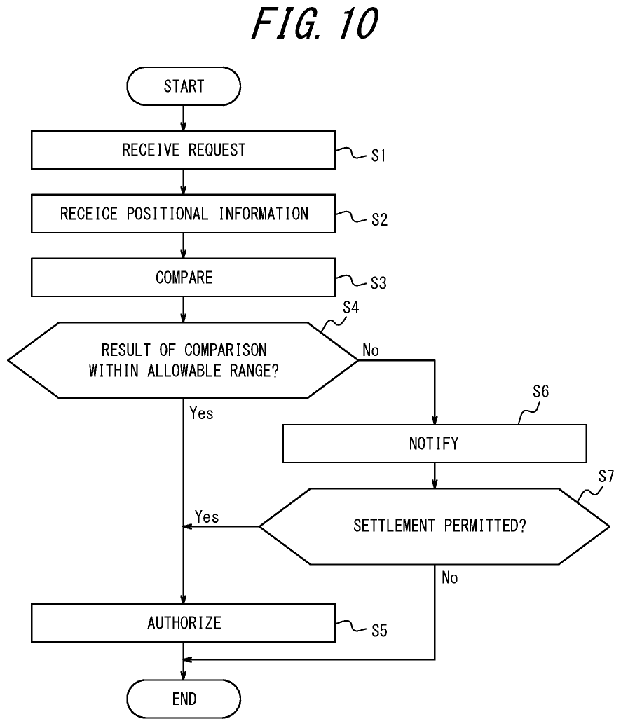

With reference to FIG. 10, a control method performed by the server 1 will be described.

In Step S1, the controller 11 of the server 1 receives a settlement request in respect of a service from the vendor terminal 5.

In Step S2, the controller 11 of the server 1 determines the vehicle ID stored in association with the settlement means ID included in the settlement request, and acquires positional information for the vehicle 2 corresponding to the vehicle ID.

In Step S3, the controller 11 of the server 1 compares the location where the service is to be provided with the location of the vehicle 2.

In Step S4, the controller 11 of the server 1 determines whether a result of the comparison is within the allowable range.

If a result of the determination is “Yes” in Step S4, then in Step S5, the controller 11 of the server 1 authorizes settlement.

If the result of the determination is “No” in Step S4, then in Step S6, the controller 11 of the server 1 notifies the user terminal 3 that a request for electronic settlement has been made.

In Step S7, the controller 11 of the server 1 determines whether the settlement has been permitted by the user of the user terminal 3.

If a result of the determination is “Yes” in Step S7, then in Step S5, the controller 11 of the server 1 authorizes the settlement.

If the result of the determination is “No” in Step S7, the controller 11 of the server 1 rejects the settlement.

As has been described, according to the present embodiment, the controller 11 of the server 1, upon receiving, from the vendor terminal 5, a request for electronic settlement in respect of a service, performs a comparison of a location where the service is to be provided with the location of the vehicle 2 associated with the settlement means 4 used for settlement of the service. When a result of the comparison is within the allowable range, the controller 11 of the server 1 authorizes the electronic settlement. According to this configuration, when the location where the service is to be provided and the location of the vehicle 2 are within the allowable range, the electronic settlement is authorized. That is, when the user who receives the service exists within the allowable range from the vehicle 2 of the user, the controller 11 of the server 1 authorizes the electronic settlement. Thus, the server 1 can improve the accuracy of user authentication, and therefore can reduce fraudulent use in which a third party impersonates the user to receive the service.

Moreover, according to the present embodiment, when the result of the comparison is outside the allowable range, the controller 11 of the server 1 notifies the user terminal 3 associated with the settlement means 4 that a request for the electronic settlement has been made. Upon the electronic settlement being permitted by the user terminal 3, the controller 11 of the server 1 authorizes the electronic settlement. According to this configuration, even if the user is outside the allowable range from the vehicle 2 of the user, the server 1 can authorize the electronic settlement upon acquiring permission from the user, and therefore can increase convenience for the user.

Moreover, according to the present embodiment, the user terminal 3 associated with the settlement means 4 is a terminal of a guardian of the holder in possession of the settlement means 4. According to this configuration, the server 1 authorizes the electronic settlement upon acquiring permission from the guardian, and therefore can further reduce the fraudulent use.

Moreover, according to the present embodiment, when the location of the vehicle 2 is included in the premises of the store including the location where the service is to be provided, the result of the comparison is within the allowable range. As an alternative example, when the location of vehicle 2 is included in a parking lot of the store including the location where the service is to be provided, the result of the comparison is within the allowable range. As another alternative example, when the distance from the location where the service is to be provided to the location of vehicle 2 is within a predetermined range, the result of the comparison is within the allowable range. According to this configuration, the server 1 can further reduce the fraudulent use.

According to the present embodiment, the settlement means 4 includes any one of a credit card, a debit card, a prepaid card, and a payment-enabled mobile device. According to this configuration, the server 1 can reduce fraudulent use attempted with various settlement means.

While the present disclosure has been described with reference to the drawings and examples, it should be noted that various modifications and revisions may be implemented by those skilled in the art based on the present disclosure. Other modifications can be made without departing from the spirit of the present disclosure. For example, functions or the like included in each means or each step can be rearranged without logical inconsistency, and a plurality of means or steps can be combined together or divided.

For example, in the above embodiment, a program that executes all or some of the functions or processing of the server 1 may be recorded on a computer readable recording medium. The computer readable recording medium includes a non-transitory computer readable medium and may be a magnetic recording apparatus, an optical disc, a magneto-optical recording medium, or a semiconductor memory. The program is distributed, for example, by selling, transferring, or lending a portable recording medium such as a Digital Versatile Disc (DVD) or a Compact Disc Read Only Memory (CD-ROM) on which the program is recorded. The program may also be distributed by storing the program in a storage of any server and transmitting the program from any server to another computer. The program may also be provided as a program product. The present disclosure may also be implemented as a program that can be executed by a processor.

1. A server that is communicably connected to a vendor terminal and a vehicle, the server comprising a controller configured to:
upon receiving, from the vendor terminal, a request for electronic settlement in respect of a service, perform a comparison of a location where the service is to be provided with a location of the vehicle, which is associated with a settlement means used for settlement of the service; and
when a result of the comparison is within an allowable range, authorize the electronic settlement.

2. The server according to claim 1, wherein the controller is configured to:
when the result of the comparison is outside the allowable range, notify a user terminal associated with the settlement means that a request for the electronic settlement has been made; and
upon the electronic settlement being permitted by the user terminal, authorize the electronic settlement.

3. The server according to claim 2, wherein
the user terminal associated with the settlement means is a terminal of a guardian of a holder in possession of the settlement means.

4. The server according to claim 1, wherein
when the location of the vehicle is included in premises of a store including the location where the service is to be provided, the result of the comparison is within the allowable range.

5. The server according to claim 1, wherein
when the location of the vehicle is included in a parking lot of a store including the location where the service is to be provided, the result of the comparison is within the allowable range.

6. The server according to claim 1, wherein
when the location of the vehicle is included within a predetermined distance from the location where the service is to be provided, the result of the comparison is within the allowable range.

7. The server according to claim 1, wherein
the settlement means comprises any one of a credit card, a debit card, a prepaid card, and a payment-enabled mobile device.

8. A non-transitory computer readable medium storing a program configured to cause a computer, as a server communicably connected to a vendor terminal and a vehicle, to execute:
receiving, from the vendor terminal, a request for electronic settlement in respect of a service;
performing a comparison of a location where the service is to be provided with a location of the vehicle, which is associated with a settlement means used for settlement of the service; and
when a result of the comparison is within an allowable range, authorizing the electronic settlement.

9. The non-transitory computer readable medium according to claim 8, wherein the program is configured to cause the computer to further execute:
when the result of the comparison is outside the allowable range,
notifying a user terminal associated with the settlement means that a request for the electronic settlement has been made; and
upon the electronic settlement being permitted by the user terminal, authorizing the electronic settlement.

10. The non-transitory computer readable medium according to claim 9, wherein
the user terminal associated with the settlement means is a terminal of a guardian of a holder in possession of the settlement means.

11. The non-transitory computer readable medium according to claim 8, wherein
when the location of the vehicle is included in premises of a store including the location where the service is to be provided, the result of the comparison is within the allowable range.

12. The non-transitory computer readable medium according to claim 8, wherein
when the location of the vehicle is included in a parking lot of a store including the location where the service is to be provided, the result of the comparison is within the allowable range.

13. The non-transitory computer readable medium according to claim 8, wherein
when the location of the vehicle is included within a predetermined distance from the location where the service is to be provided, the result of the comparison is within the allowable range.

14. The non-transitory computer readable medium according to claim 8, wherein
the settlement means comprises any one of a credit card, a debit card, a prepaid card, and a payment-enabled mobile device.

15. A control method performed by a server communicably connected to a vendor terminal and a vehicle, the control method comprising:
receiving, from the vendor terminal, a request for electronic settlement in respect of a service;
performing a comparison of a location where the service is to be provided with a location of the vehicle, which is associated with a settlement means used for settlement of the service; and
when a result of the comparison is within an allowable range, authorizing the electronic settlement.

16. The control method according to claim 15, further comprising:
when the result of the comparison is outside the allowable range,
notifying a user terminal associated with the settlement means that a request for the electronic settlement has been made; and
upon the electronic settlement being permitted by the user terminal, authorizing the electronic settlement.

17. The control method according to claim 16, wherein
the user terminal associated with the settlement means is a terminal of a guardian of a holder in possession of the settlement means.

18. The control method according to claim 15, wherein
when the location of the vehicle is included in premises of a store including the location where the service is to be provided, the result of the comparison is within the allowable range.

19. The control method according to claim 15, wherein
when the location of the vehicle is included in a parking lot of a store including the location where the service is to be provided, the result of the comparison is within the allowable range.

20. The control method according to claim 15, wherein
when the location of the vehicle is included within a predetermined distance from the location where the service is to be provided, the result of the comparison is within the allowable range.
